(19) United States
(12) Patent Application Publication
(10) Pub. No.: US 2009/0028261 A1
(43) Pub. Date: Jan. 29, 2009

(54) METHOD AND APPARATUS FOR REDUCING SIGNALING OVERHEAD DURING A DUAL CODEWORD HYBRID AUTOMATIC REPEAT REQUEST OPERATION

(75) Inventors: Guodong Zhang, Farmingdale, NY (US); Robert L. Olesen, Huntington, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/179,130

(22) Filed: Jul. 24, 2008

Related U.S. Application Data
(60) Provisional application No. 60/952,091, filed on Jul. 26, 2007.

(51) Int. Cl. H04L 5/12; H04B 7/02

(52) U.S. Cl. 375/261; 375/267

(57) ABSTRACT

A method and an apparatus for reducing overhead in signaling for downlink dual codewords in a wireless transmit receive unit (WTRU) with spatial multiplexing are disclosed. The method includes signaling a number of codewords to be used, signaling modulation scheme coding, reducing overhead for signaling of transport block size (TBS), and/or reducing overhead for signaling associated with error correction.

### CROSS REFERENCE TO RELATED APPLICATIONS

This application claims the benefit of U.S. Provisional Application No. 60/952,091 filed on Jul. 26, 2007, which is incorporated by reference as if fully set forth.

### FIELD OF INVENTION

The present invention is related to wireless communications.

### BACKGROUND

To keep the technology competitive, both third generation partnership project (3GPP) and 3GPP2 are considering long term evolution (LTE) for radio interface and network architecture.

To take advantage of multiple-input multiple-output (MIMO) technology, also called spatial multiplexing, two codewords are used for hybrid automatic repeat request (HARQ) in the downlink (DL) communication of evolved universal terrestrial radio access (E-UTRA). However, the dual codeword operation increases signaling overhead.

If the assignment information for a codeword is signaled independently of the other codeword's assignment information, then the signaling requirements are substantially increased. For example, if the transport block size (TBS) for each codeword is indicated by six bits in an assignment, then the dual codeword operation requires twelve bits for TBS signaling.

In general, if each codeword uses N HARQ processes, resulting in ┌log₂ N┐ bits overhead, then dual codeword operation uses 2N HARQ processes. Approximately |log₂(2N)²| bits are needed for signaling HARQ process identifiers (IDs) when full flexibility is allowed.

To reduce the signaling, more efficient signaling schemes would be beneficial for dual codeword operation.

### SUMMARY

A method and apparatus for reducing overhead for signaling of dual codeword information in a wireless communication system with spatial multiplexing includes signaling a number of codewords to be used, the modulation and coding for each codeword, the transport block size for each codeword, and/or the HARQ process IDs for each codeword.

A method for reducing signaling overhead for a MIMO-capable wireless transmit/receive unit (WTRU) receiving and using the modulation of a primary codeword and a secondary codeword, the transport block size of the primary codeword and the secondary codeword, and a HARQ process ID for the primary codeword and the secondary codeword is also described.

### BRIEF DESCRIPTION OF THE DRAWINGS

A more detailed understanding may be had from the following description, given by way of example and to be understood in conjunction with the accompanying drawings wherein:

FIG. 1 shows a wireless communication system including a Node-B and a WTRU;

FIG. 2 illustrates a downlink assignment message format;

FIG. 3 shows a downlink signaling procedure; and

FIGS. 4A, 4B, and 4C collectively illustrate signaling of TBS in accordance with a disclosed method.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment.

When referred to hereafter, the terminology “base station” includes but is not limited to a Node-B, a site controller, an access point (AP), or any other type of interfacing device capable of operating in a wireless environment.

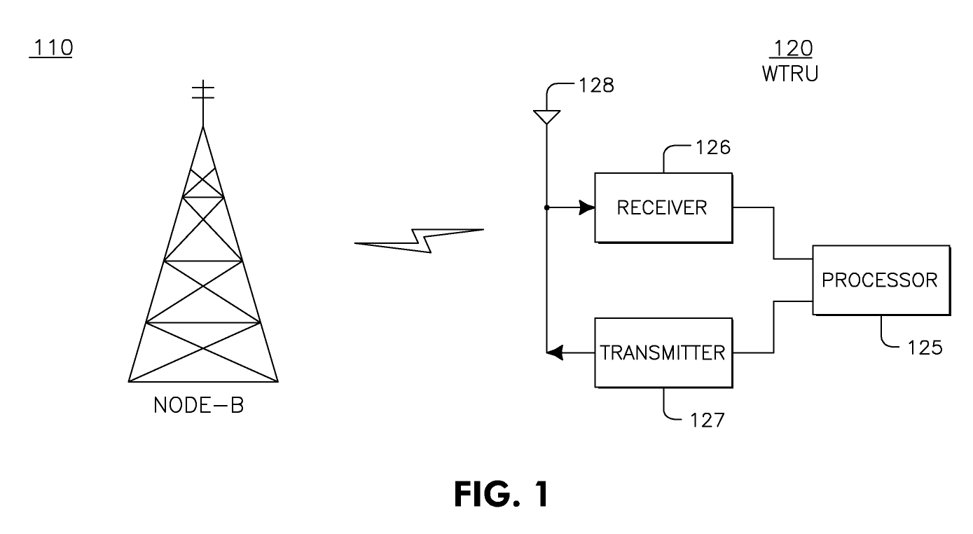

FIG. 1 shows a wireless communication system including a Node-B 110 and a WTRU 120. As shown in FIG. 1, in addition to components included in a typical WTRU, the WTRU 120 includes a processor 125, a receiver 126 which is in communication with the processor 125, a transmitter 127 which is in communication with the processor 125, and an antenna 128 which is in communication with the receiver 126 and the transmitter 127 to facilitate the transmission and reception of wireless data. The WTRU 120 wirelessly communicates with a base station (Node-B) 110.

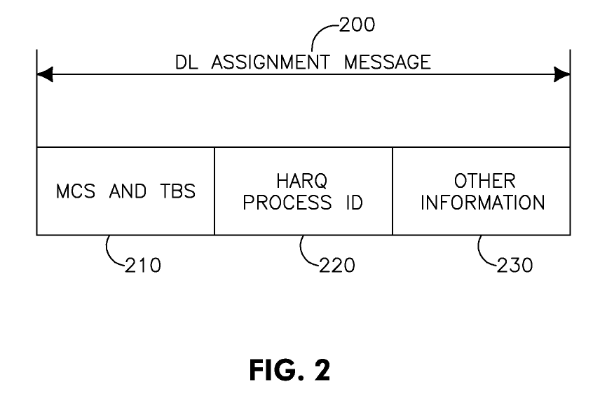

FIG. 2 shows a downlink assignment message 200. The downlink assignment message 200 comprises assignment parameter fields including a modulation and coding scheme (MCS) and TBS field 210, an HARQ process ID field 220 and an “other information” field 230. These assignment parameter fields 210, 220 and 230 included in the downlink assignment message 200 are signaled from the Node-B 110 to the WTRU 120 via a physical downlink control channel (PDCCH). Although not described in detail herein, one of skill in the art would understand that the assignment message 200 may also be applicable for transmission via an uplink channel.

In a first embodiment, overhead is reduced for signaling the modulation and the number of codewords in a downlink signaling assignment. In this embodiment, a plurality of bits, (such as three bits), are used to jointly indicate the number of codewords (i.e., streams) used in the downlink communication of E-UTRA and the modulation type used for those one or two codewords.

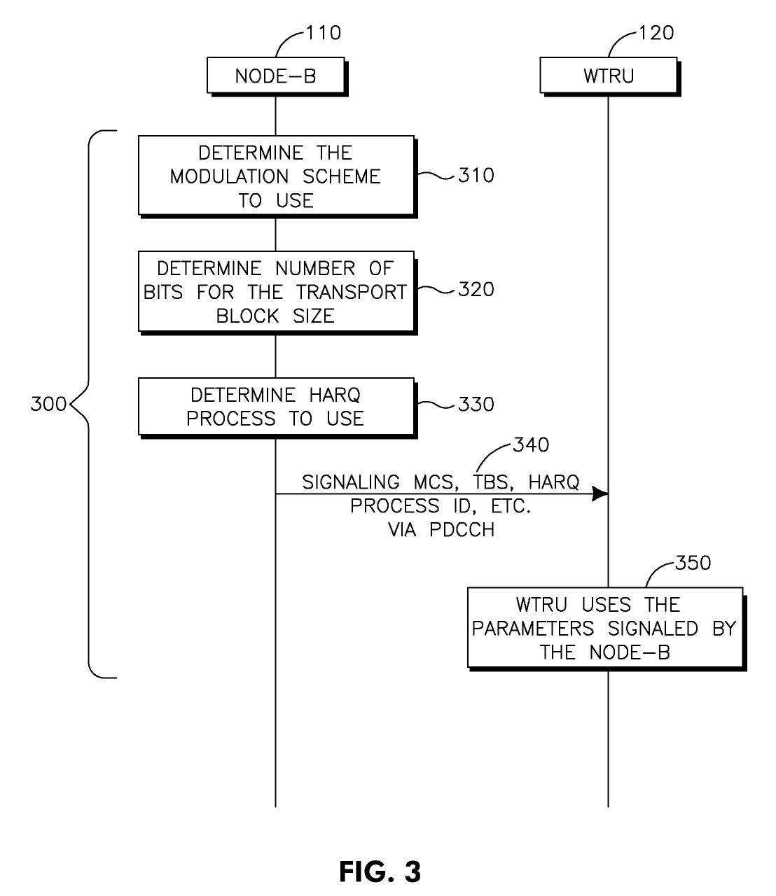

FIG. 3 shows a downlink signaling procedure 300 according to the first embodiment. In step 310, the Node-B 110 determines the modulation scheme to use (step 310). In step 320, the Node-B 110 determines the number of bits for the TBS. In step 330, the Node-B 110 determines which HARQ process is to be used. Although shown in FIG. 3 as three separate decisions or determinations, 310, 320, 330 in a specific order, those of skill in the art would understand that this is for ease of explanation. One decision, or multiple decisions in a different order, may be made.

Still referring to FIG. 3, in step 340, the Node-B 110 signals the modulation types, the TBSs and the HARQ process ID parameters via a downlink channel, (such as the PDCCH), to the WTRU 120. In step 350, the WTRU 120 uses the parameters received from the Node-B 110 in detecting and decoding received downlink data. The codeword modulation signaling described in this embodiment is summarized in Table 1.

TABLE 1

| | | Modulation of | Modulation of the |
|---|---|---|---|
| | Number of | the primary | secondary |
| Signaling | codewords | codeword | codeword |
| 000 | 1 | QPSK | N/A |
| 001 | 1 | 16QAM | N/A |
| 010 | 1 | 64QAM | N/A |
| 011 | 2 | QPSK | QPSK |
| 100 | 2 | 16QAM | QPSK |
| 101 | 2 | 16QAM | 16QAM |
| 110 | 2 | 64QAM | 16QAM |
| 111 | 2 | 64QAM | 64QAM |

To reduce signaling overhead further, the number of bits used for the TBS and the HARQ process IDs may also be reduced as discussed in the second and third embodiments, respectively.

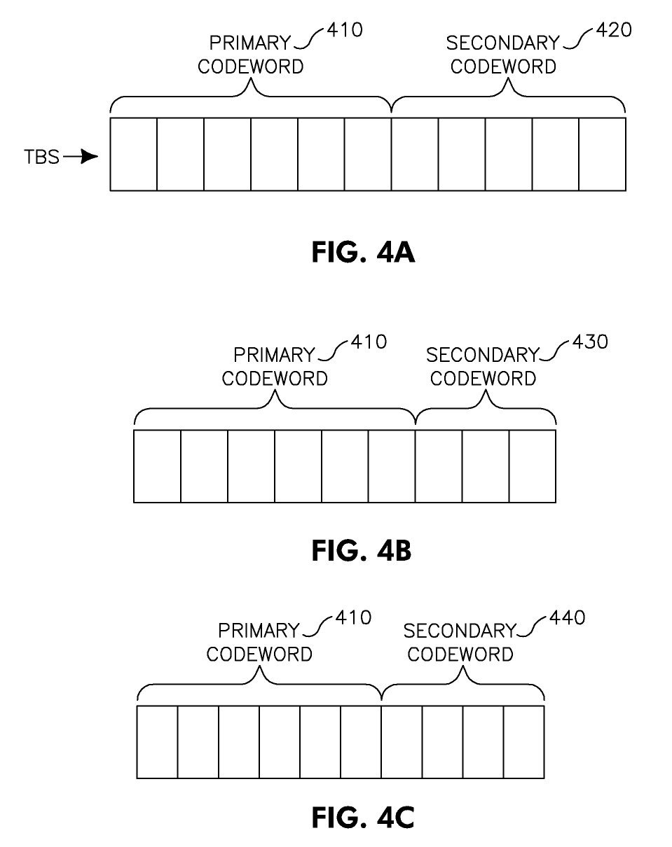

FIGS. 4A-4C illustrate a second embodiment, whereby overhead is reduced for signaling the TBS when dual codewords are used.

In a first example shown by FIG. 4A, the TBS of the primary codeword 410 is indicated using six bits, and a lesser number of bits (five, in this example) are used to indicate the TBS of the secondary codeword 420. Using a lesser number of bits for the TBS of the secondary codeword may be made possible, for example, by reducing the resolution of the TBS for the secondary codeword 420.

In a second example shown by FIG. 4B, the same primary codeword 410 is used, and a secondary codeword 430 having three bits is used to indicate the difference between the TBS of the primary codeword 410 and the secondary codeword 430. In this manner, the difference between the TBS of the primary codeword 410 and the TBS of the second codeword 430 (i.e., three bits) is signaled, instead of only signaling the TBS of the second codeword.

In a third example shown by FIG. 4C, the same primary codeword 410 is used, and a secondary codeword 440 having four bits is used to indicate the difference between the TBS of the primary codeword 410 and the secondary codeword 440.

In a third embodiment, overhead for signaling HARQ process IDs is reduced as will be described hereinafter. It should be understood that each single codeword uses N HARQ processes, that results in an overhead of ┌log₂ N┐ bits. Dual codeword operation therefore uses 2N HARQ processes. The number of codewords may be indicated by other signaling such as for the MCS, TBS, precoder information, and the like.

A first alternative implements a fixed division of the HARQ processes that are used for the primary and the secondary codewords. For example, the primary codeword may use only HARQ processes 1, 2, . . . , N, and the secondary codeword may use only HARQ processes N+1, N+2, . . . , 2N. In this case, the signaling overhead is 2┌log₂ N┐ bits. Alternatively, because the primary codeword and the secondary codeword experience different channel qualities, non-equal numbers of HARQ processes may be assigned to each codeword.

A second alternative for reducing downlink signaling overhead for HARQ process IDs allows limited pairs of HARQ processes ({1a, 1b}, {2a, 2b}, . . . , {Na, Nb}) for a primary and secondary codeword pair. For a single codeword transmission or retransmission, any single HARQ process (i.e., 1a, 2b, etc.) is allowed. This limits the usage of the HARQ processes. The signaling overhead is ┌log₂ N┐+1 bits determined by the single codeword case. Table 2 is an example of the proposed signaling method with N=6. The proposed method is also applicable to other N values.

TABLE 2

| Number | | | |
|---|---|---|---|
| of codewords | HARQ | HARQ process ID | HARQ process |
| (indicated by other | process ID | of primary | ID of secondary |
| signals) | Signaling | codeword | codeword |
| 2 | 0000 | 1a | 1b |
| 2 | 0001 | 2a | 2b |
| 2 | 0010 | 3a | 3b |
| 2 | 0011 | 4a | 4b |
| 2 | 0100 | 5a | 5b |
| 2 | 0101 | 6a | 6b |
| 1 | 0000 | 1a | N/A |
| 1 | 0001 | 2a | N/A |
| 1 | 0010 | 3a | N/A |
| 1 | 0011 | 4a | N/A |
| 1 | 0100 | 5a | N/A |
| 1 | 0101 | 6a | N/A |
| 1 | 0110 | N/A | 1b |
| 1 | 0111 | N/A | 2b |
| 1 | 1000 | N/A | 3b |
| 1 | 1001 | N/A | 4b |
| 1 | 1010 | N/A | 5b |
| 1 | 1011 | N/A | 6b |

The signaling overhead in the second alternative is dominated by the single codeword case. In the case of dual codewords, the dual codeword uses less signaling overhead. By signaling predetermined pairs of codewords, the amount of signaling is greatly reduced. If the number of codewords is two, then extra pairs in addition to the pairs of the HARQ processes used in the second method are added for the dual codeword to increase flexibility in usage of the HARQ processes. Extra pairs allow the transmission of misaligned HARQ processes on the two codewords. This third alternative, shown in Table 3, has the same overhead as the second alternative, but has less restraint in usage of the HARQ processes.

TABLE 3

| | | | HARQ | HARQ |
|---|---|---|---|---|
| Comparison | | HARQ | process ID | process ID |
| of primary to | Number of | process ID | of primary | of secondary |
| secondary codeword | codewords | signaling | codeword | codeword |
| The same | 2 | 0000 | 1a | 1b |
| The same | 2 | 0001 | 2a | 2b |
| The same | 2 | 0010 | 3a | 3b |
| The same | 2 | 0011 | 4a | 4b |
| The same | 2 | 0100 | 5a | 5b |
| The same | 2 | 0101 | 6a | 6b |
| HARQ process ID of | 2 | 0110 | 1a | 2b |
| secondary codeword | | | | |
| differs by 1 | | | | |
| HARQ process ID of | 2 | 0111 | 2a | 3b |
| secondary codeword | | | | |
| differs by 1 | | | | |
| HARQ process ID of | 2 | 1000 | 3a | 4b |
| secondary codeword | | | | |
| differs by 1 | | | | |
| HARQ process ID of | 2 | 1001 | 4a | 5b |
| secondary codeword | | | | |
| differs by 1 | | | | |
| HARQ process ID of | 2 | 1010 | 5a | 6b |
| secondary codeword | | | | |
| differs by 1 | | | | |
| HARQ process ID of | 2 | 1011 | 6a | 1b |
| secondary codeword | | | | |
| differs by 1 | | | | |
| HARQ process ID of | 2 | 1100 | 1a | 3b |
| secondary codeword | | | | |
| differs by 2 | | | | |
| HARQ process ID of | 2 | 1101 | 2a | 4b |
| secondary codeword | | | | |
| differs by 2 | | | | |
| HARQ process ID of | 2 | 1110 | 4a | 6b |
| secondary codeword | | | | |
| differs by 2 | | | | |
| HARQ process ID of | 2 | 1111 | 5a | 1b |
| secondary codeword | | | | |
| differs by 2 | | | | |
| The same | 1 | 0000 | 1a | N/A |
| The same | 1 | 0001 | 2a | N/A |
| The same | 1 | 0010 | 3a | N/A |
| The same | 1 | 0011 | 4a | N/A |
| The same | 1 | 0100 | 5a | N/A |
| The same | 1 | 0101 | 6a | N/A |
| The same | 1 | 0110 | N/A | 1b |
| The same | 1 | 0111 | N/A | 2b |
| The same | 1 | 1000 | N/A | 3b |
| The same | 1 | 1001 | N/A | 4b |
| The same | 1 | 1010 | N/A | 5b |
| The same | 1 | 1011 | N/A | 6b |

Table 4 shows an example of the proposed signaling of a fourth alternative with N=6 and allowing the HARQ process ID of either codeword to differ by one index number.

TABLE 4

| | | | | HARQ |
|---|---|---|---|---|
| | | | HARQ | process |
| | Number | HARQ | process ID | ID of |
| Compared to | of code- | process ID | of primary | secondary |
| Second method | words | Signaling | codeword | codeword |
| The same | 2 | 0000 | 1a | 1b |
| The same | 2 | 0001 | 2a | 2b |
| The same | 2 | 0010 | 3a | 3b |
| The same | 2 | 0011 | 4a | 4b |
| The same | 2 | 0100 | 5a | 5b |
| The same | 2 | 0101 | 6a | 6b |
| HARQ process ID of | 2 | 0110 | 1a | 2b |
| secondary codeword differs | | | | |
| by 1 | | | | |
| HARQ process ID of | 2 | 0111 | 2a | 3b |
| secondary codeword differs | | | | |
| by 1 | | | | |
| HARQ process ID of | 2 | 1000 | 3a | 4b |
| secondary codeword differs | | | | |
| by 1 | | | | |
| HARQ process ID of | 2 | 1001 | 4a | 5b |
| secondary codeword differs | | | | |
| by 1 | | | | |
| HARQ process ID of | 2 | 1010 | 5a | 6b |
| secondary codeword differs | | | | |
| by 1 | | | | |
| HARQ process ID of | 2 | 1011 | 6a | 1b |
| secondary codeword differs | | | | |
| by 1 | | | | |
| HARQ process ID of | 2 | 1100 | 2a | 1b |
| primary codeword differs | | | | |
| by 1 | | | | |
| HARQ process ID of | 2 | 1101 | 3a | 2b |
| primary codeword differs | | | | |
| by 1 | | | | |
| HARQ process ID of | 2 | 1110 | 5a | 4b |
| primary codeword differs | | | | |
| by 1 | | | | |
| HARQ process ID of | 2 | 1111 | 6a | 5b |
| primary codeword differs | | | | |
| by 1 | | | | |
| The same | 1 | 0000 | 1a | N/A |
| The same | 1 | 0001 | 2a | N/A |
| The same | 1 | 0010 | 3a | N/A |
| The same | 1 | 0011 | 4a | N/A |
| The same | 1 | 0100 | 5a | N/A |
| The same | 1 | 0101 | 6a | N/A |
| The same | 1 | 0110 | N/A | 1b |
| The same | 1 | 0111 | N/A | 2b |
| The same | 1 | 1000 | N/A | 3b |
| The same | 1 | 1001 | N/A | 4b |
| The same | 1 | 1010 | N/A | 5b |
| The same | 1 | 1011 | N/A | 6b |

An evolved Node-B (eNode-B) may realign the HARQ process IDs of the two codewords whenever the misalignment between HARQ process IDs of the two codewords is larger than a predetermined threshold. Therefore, the impact of the HARQ process ID signaling described above has the least limitation and impact on usage of the HARQ processes.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method of reducing signaling overhead for a multiple-input multiple-output (MIMO) capable wireless transmit/receive unit (WTRU), the method comprising:
receiving a modulation type of a primary codeword and a modulation type of a secondary codeword;
receiving a transport block size (TBS) of the primary codeword and a TBS of the secondary codeword;
receiving a hybrid automatic repeat request (HARQ) process identifier (ID) for the primary codeword and an HARQ process ID for the secondary codeword; and
using the modulation types, the TBSs and the HARQ process IDs of the primary and secondary codewords to decode and detect the primary and secondary codewords.

2. The method of claim 1 further comprising receiving a plurality of bits indicating the TBS of the primary codeword and a plurality of bits indicating the TBS of the secondary codeword.

3. The method of claim 2 wherein the bits that indicate the TBS of the secondary codeword indicate the difference between the TBS of the first codeword and the TBS of the secondary codeword.

4. The method of claim 3 wherein the number of bits indicating the TBS of the secondary codeword is less than or equal to the number of bits indicating the TBS of the primary codeword.

5. The method of claim 4 wherein the number of bits indicating the TBS of the primary codeword is six.

6. The method of claim 4 wherein the number of bits indicating the TBS of the secondary codeword is five.

7. The method of claim 4 wherein the number of bits indicating the TBS of the secondary codeword is three.

8. The method of claim 1 wherein the HARQ process ID for a single codeword is limited to a single process ID for either the primary codeword or the secondary codeword.

9. The method of claim 1 wherein a plurality of bits are used to indicate the number of codewords used in a downlink communication.

10. The method of claim 1 wherein a plurality of bits are used to indicate the modulation types of the primary and secondary codewords.

11. The method of claim 10 wherein the modulation type of the primary codeword is quadrature phase-shift keying (QPSK).

12. The method of claim 10 wherein the modulation type of the primary codeword is 16 quadrature amplitude modulation (16QAM).

13. The method of claim 10 wherein the modulation type of the primary codeword is 64 quadrature amplitude modulation (64QAM).

14. The method of claim 10 wherein the modulation type of the secondary codeword is quadrature phase-shift keying (QPSK).

15. The method of claim 10 wherein the modulation type of the secondary codeword is 16 quadrature amplitude modulation (16QAM).

16. The method of claim 10 wherein the modulation type of the secondary codeword is 64 quadrature amplitude modulation (64QAM).

17. The method of claim 10 wherein the number of bits indicating the modulation types of the primary and secondary codewords is three.

18. The method of claim 1 wherein the primary codeword uses a first set of HARQ processes and the secondary codeword uses a second set of HARQ processes.

19. The method of claim 18 wherein 2┌log₂ N┐ bits are used for the signaling overhead.

20. The method of claim 1 wherein a first number of HARQ processes is assigned to the primary codeword and a second number of HARQ processes is assigned to the secondary codeword, wherein the second number is different than the first number.

21. The method of claim 1 wherein limited pairs of HARQ processes are used for the primary and secondary codewords.

22. The method of claim 1 wherein a plurality of bits are used to indicate the HARQ process IDs of the primary and secondary codewords.

23. The method of claim 22 wherein the number of bits indicating the HARQ process IDs of the primary and secondary codewords is four.

24. The method of claim 1 wherein predetermined pairs of codewords are signaled and extra pairs of HARQ processes are added for the codeword pairs.

25. The method of claim 1 wherein the HARQ process ID of the secondary codeword differs by one index number from the HARQ process ID of the primary codeword.

26. A wireless transmit/receive unit (WTRU) comprising:
a receiver configured to receive:
a modulation type of a primary codeword and a modulation type of a secondary codeword;
a transport block size (TBS) of the primary codeword and a TBS of the secondary codeword; and
a hybrid automatic repeat request (HARQ) process identifier (ID) for the primary codeword and an HARQ process ID for the secondary codeword; and
a processor configured to use the modulation types, the TBSs and the HARQ process IDs of the primary and secondary codewords to decode and detect the primary and secondary codewords.

27. The WTRU of claim 26 wherein the receiver is further configured to receive a plurality of bits that indicate the TBS of the primary codeword and a plurality of bits that indicate the TBS of the secondary codeword.

28. The WTRU of claim 27 wherein the bits that indicate the TBS of the secondary codeword indicate the difference between the TBS of the first codeword and the TBS of the secondary codeword.

29. The WTRU of claim 28 wherein the number of bits indicating the TBS of the secondary codeword is less than or equal to the number of bits indicating the TBS of the primary codeword.

30. The WTRU of claim 29 wherein the number of bits indicating the TBS of the primary codeword is six.

31. The WTRU of claim 29 wherein the number of bits indicating the TBS of the secondary codeword is five.

32. The WTRU of claim 29 wherein the number of bits indicating the TBS of the secondary codeword is three.

33. The WTRU of claim 26 wherein the HARQ process ID for a single codeword is limited to a single process ID for either the primary codeword or the secondary codeword.

34. The WTRU of claim 26 wherein a plurality of bits are used to indicate the number of codewords used in a downlink communication.

35. The WTRU of claim 26 wherein a plurality of bits are used to indicate the modulation types of the primary and secondary codewords.

36. The WTRU of claim 35 wherein the modulation type of the primary codeword is quadrature phase-shift keying (QPSK).

37. The WTRU of claim 35 wherein the modulation type of the primary codeword is 16 quadrature amplitude modulation (16QAM).

38. The WTRU of claim 35 wherein the modulation type of the primary codeword is 64 quadrature amplitude modulation (64QAM).

39. The WTRU of claim 35 wherein the modulation type of the secondary codeword is quadrature phase-shift keying (QPSK).

40. The WTRU of claim 35 wherein the modulation type of the secondary codeword is 16 quadrature amplitude modulation (16QAM).

41. The WTRU of claim 35 wherein the modulation type of the secondary codeword is 64 quadrature amplitude modulation (64QAM).

42. The WTRU of claim 35 wherein the number of bits indicating the modulation types of the primary and secondary codewords is three.

43. The WTRU of claim 26 wherein the primary codeword uses a first set of HARQ processes and the secondary codeword uses a second set of HARQ processes.

44. The WTRU of claim 43 wherein 2┌log₂ N┐ bits are used for the signaling overhead.

45. The WTRU of claim 26 wherein a first number of HARQ processes is assigned to the primary codeword and a second number of HARQ processes is assigned to the secondary codeword, wherein the second number is different than the first number.

46. The WTRU of claim 26 wherein limited pairs of HARQ processes are used for the primary and secondary codewords.

47. The WTRU of claim 26 wherein a plurality of bits are used to indicate the HARQ process IDs of the primary and secondary codewords.

48. The WTRU of claim 47 wherein the number of bits indicating the HARQ process IDs of the primary and secondary codewords is four.

49. The WTRU of claim 26 wherein predetermined pairs of codewords are signaled and extra pairs of HARQ processes are added for the codeword pairs.

50. The WTRU of claim 26 wherein the HARQ process ID of the secondary codeword differs by one index number from the HARQ process ID of the primary codeword.

51. A method implemented in a base station, the method comprising:
selecting a modulation of a primary codeword and a secondary codeword, a transport block size (TBS) and a hybrid automatic repeat request (HARQ) process identifier (ID); and
transmitting the modulations, the TBSs and the HARQ process IDs of the primary and secondary codewords.
